(19) United States
(12) Patent Application Publication
(10) Pub. No.: US 2014/0098652 A1
(43) Pub. Date: Apr. 10, 2014

(54) SIDE MOUNTED LASER DIODE ON A THERMAL ASSISTED MAGNETIC RECORDING HEAD ASSEMBLY WITH INTEGRATED MICROACTUATOR

(71) Applicant: HGST NETHERLANDS B.V., Amsterdam (NL)

(72) Inventors: Tadaaki Tomiyama, Tokyo (JP); Kenji Ito, Fujisawa-shi (JP); Irizo Naniwa, Fujisawa-shi (JP)

(73) Assignee: HGST NETHERLANDS B.V., Amsterdam (NL)

(21) Appl. No.: 13/646,462

(22) Filed: Oct. 5, 2012

(51) Int. Cl. G11B 5/60; G11B 13/04

(52) U.S. Cl. 369/13.02; G9B/5.229; G9B/13.002

(57) ABSTRACT

A magnetic data recording system employing a slider having a laser diode mounted to a side surface of the slider rather than to a back surface opposite the air bearing surface. The laser diode provides a light source for thermal assisted recording. Locating the laser diode at the side surface eliminates the possibility of contact between laser diodes of adjacent sliders and allows larger, more powerful laser diodes to be employed. In addition, placing the laser diode at the side allows a micro-actuator to be attached to the back side surface of the slider, thereby allowing both thermally assisted recording and micro-actuation to be used in the same recording system.

### FIELD OF THE INVENTION

The present invention relates to magnetic data recording and more particularly to a magnetic data recording system employing a slider that is formed with a laser diode for thermally assisted recording, wherein the laser diode is mounted at a side surface of the slider allowing for the use of both micro-actuation and thermally assisted recording and eliminating the possibility of contact between laser diodes of adjacent sliders.

### BACKGROUND OF THE INVENTION

Various techniques have been studied as methods of achieving high recording density in magnetic disc drives (HDD). Thermal assisted recording (TAR) is one technique for improving surface recording density. At very high data densities, a magnetic media can become magnetically unstable. As the size of magnetic grains and the size of magnetic bits become very small they can become easily de-magnetized leading to loss of data. In order to prevent this, the magnetic media can be constructed such that the recording layer has a very high coercivity. However, such a high coercivity would require such a high write field as to be un-writable. In order to overcome this, thermally assisted recording can be used to temporarily, locally lower the coercivity of the media at the location of writing. This method can involve the use of a laser diode which produces a light spot that is delivered to the desired location near the point of recording to the magnetic media. The laser diode is typically located on a back side surface of the slider, opposite the air bearing surface and can be delivered to the desired location at the air bearing surface by a waveguide.

Another method for increasing disk drive performance has to do with servo tracking As the data density increases so does the track density. This makes it ever more difficult to maintain the location of the slider over the desired track with sufficient accuracy to effectively write and read data. One way to improve servo accuracy is through the use of micro-actuation. Course servo actuation is provided by an actuator such as a voice coil motor that moves an entire suspension assembly to locate the slider over the desired track. Fine tuning of the location of the read and write elements can be provided by micro-actuation. Micro-actuation can include the use of micro-actuators such as piezoelectric actuators connected with the slider. The micro-actuators deflect the slider slightly to move the location of the read and write the heads relative to data tracks on the magnetic media.

Furthermore, in the method of mounting a laser diode on the rear face of the slider, in the case of an HDD construction in which two or more magnetic discs are provided, when mounting the HDDs, there is a possibility of laser diodes that are mounted on the sliders in piggy-back fashion coming into contact with one another. This imposes restrictions on the length of the laser diodes. Since this length of the laser diode is correlated with laser intensity, there is a concern that fully satisfactory performance might not be achieved in such cases. The micro-actuators are typically located at the back side of the slider opposite the air bearing surface.

However, the above described thermally assisted heating system presents several challenges. In a magnetic recording system, several disks and sliders are used, the sliders being connected to an assembly of suspensions such that each slider reads and write to a surface of a magnetic media. In order to prevent laser diodes of one slider from coming into contact with a laser diode of an adjacent slider, the size of the laser diode must be limited. This in turn limits the amount of power that the laser diode can provide for heating the magnetic media. In addition, the mounting of the laser diode and the mounting of a micro-actuator interfere with one another, making the use of both micro-actuation and thermally assisted recording in the same data recording system impractical.

### SUMMARY OF THE INVENTION

The present invention provides a slider for magnetic data recording that includes a slider body having an air bearing surface, and a side surface oriented perpendicular to the air bearing surface, and a laser diode attached to the side surface of the slider body.

The laser diode can be connected with either a side surface of the slider body or with a trailing end surface of the slider body. A laser diode can be provided which can be configured with a bend to deliver light from the laser diode to the air bearing surface of the slider body.

Locating the laser diode at a side surface of the slider body rather than at the back surface opposite the air bearing surface provides several advantages. For example, locating the laser diode at a side surface eliminates any chance of a laser diode from one slider contacting a laser diode of an adjacent slider in a stack of suspensions and sliders. Also, because there is no chance of contact between laser diodes of adjacent sliders, there is more room for the laser diode. This means that the laser diode can be larger, providing ample power for effective heat assisted recording.

In addition, placing the laser diode at the side of the slider leaves the back side surface opposite the air bearing surface free for the attachment of a micro-actuator such as a piezo-electric actuator. Previously it had been necessary to choose between the use of a micro-actuator for fine tuning of servo tracking or the use of thermally assisted recording. The present inventions make possible the use of both of these (previously mutually exclusive) recording systems.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3 is a side view of a slider according to an embodiment of the invention;

FIG. 4 is a view of a trailing end surface of the slider of FIG. 3 as seen from line 4-4 of FIG. 3;

FIG. 5 is a side view of a slider according to an alternate embodiment of the invention;

FIG. 6 is a view of a trailing end surface of the slider of FIG. 5 as seen from line 6-6 of FIG. 5; and

FIG. 7 is an enlarged view of a portion of a slider according to an embodiment of the invention showing a write element and read element formed thereon.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

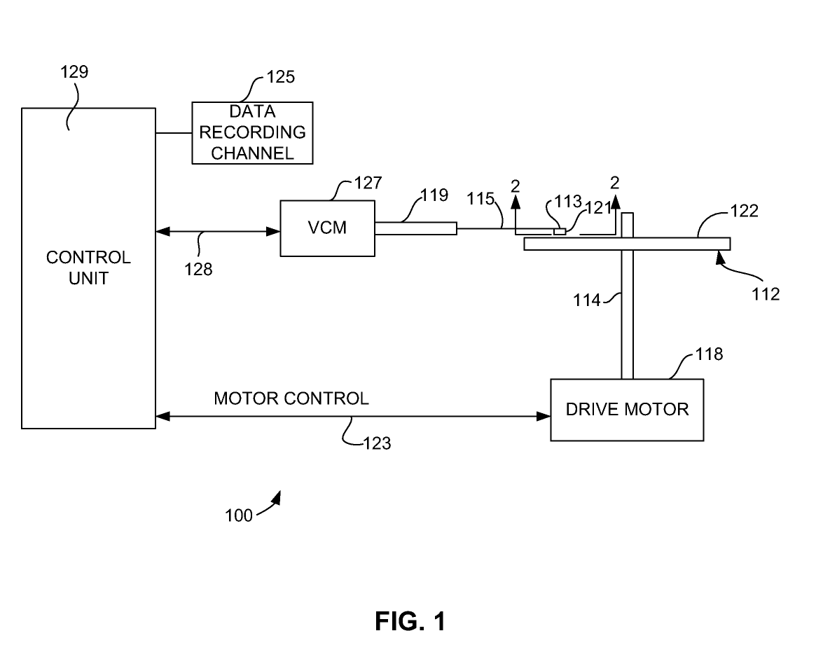

Referring now to FIG. 1, there is shown a disk drive 100 embodying this invention. As shown in FIG.1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuation means 127. The actuation means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

In order to ensure that data recorded to a medium is magnetically stable at very small bit sizes it is necessary to increase the magnetic coercivity of the magnetic media to which the data is written. However, a magnetic media having such a high magnetic coercivity requires a very high magnetic write field, which may not be attainable in a magnetic write head configured for writing a very small bit of data. One way to overcome this conflict by the use of thermally assisted recording. In a thermally assisted recording system, the area to which data is to be written is temporarily, locally heated. This reduces the magnetic coercivity temporarily, allowing the magnetic data bit to be recorded. This area of the media then cools which increases the coercivity, resulting in a stable, recorded bit of data.

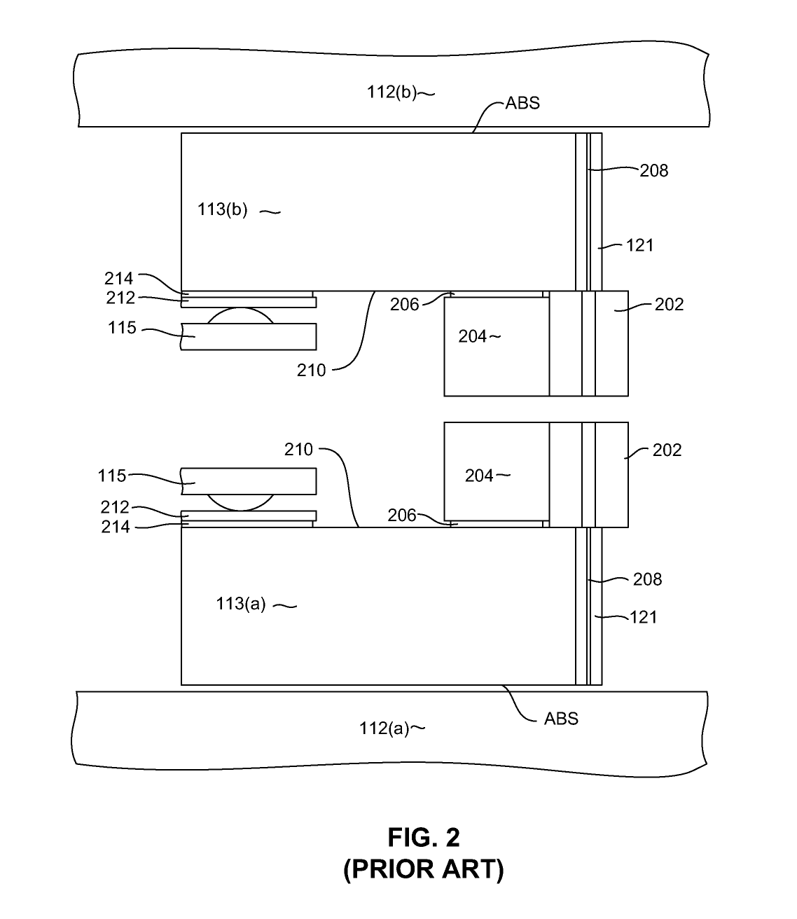

FIG. 2 shows an enlarged side view of a portion of a prior art magnetic recording system and illustrates a challenge presented by such a system. As those skilled in the art will appreciate, most data recording systems include a stack of magnetic disks. A suspension assembly is constructed so that there is a slider adjacent to each surface of each disk for recording and reading data to the surfaces of the disks. FIG. 2 shows a pair of magnetic media 112(a) and 112(b). A slider 113(a) faces the surface of the disk 112(a) and a slider 113(b) faces an opposing surface of the adjacent disk 112(b). Each of the sliders 113(a), 113(b) is attached to a flexure 212 by an adhesion layer 214. The flexure 212 is connected with a load beam 115

Each of the sliders 113(a), 113(b) includes a magnetic head 121 that includes a magnetic read sensor (not shown) and a magnetic write element (also not shown). In order to locally heat the magnetic media 112(a), 112(b), a laser diode 202 is provided on each of the sliders 113(a), 113(b). The laser diode 202 can be attached to a sub-mount 204 that can be affixed to the slider body 113 by an adhesion layer 206. A waveguide 208 is provided which passes from the laser diode 202 through the magnetic head to the air bearing surface (ABS) surface of the slider 113. In this way the waveguide 208 can direct the light pulse to the desired location on the ABS surface of the magnetic head 121 in order to locally heat the media 112.

As can be seen, in FIG. 2, in such a prior art system, the laser diode 202 and sub-mount 204 are mounted on the back side 210 of the slider body 113 opposite the ABS. This arrangement poses at least a couple of challenges. First, as can be seen in FIG. 2, the two sliders 113(a), 113(b) are arranged in opposing directions opposite one another, with the back sides of the 210 of slider 113(a) facing the backside 210 of slider 113(b). As can be seen, the laser diodes 202 extend toward one another. In order to ensure that the laser diodes do not contact one another, thereby causing damage to the laser diodes 202, the size of the laser diodes must be limited. Limiting the size of the laser diode limits the power that the laser diode 202 can produce.

Another problem presented by the above described arrangement of the diode 202 has to do with the use of micro-actuators. Maintaining accurate alignment of the head over a data track can be difficult at very small track-widths at very high data densities. One way to accurately maintain the location of the head over a data track is to use micro-actuators such as piezoelectric actuators. Such actuators (not shown in FIG. 2) can be connected with the slider 113 and flexure 212 and operate to bend the flexure 212 slightly to deflect the slider 113 slightly to one side or the other. However, in order to use such piezoelectric actuators, they must be connected with the slider, and the location of the connection would necessarily overlap with the connection of the diode 202 and sub-mount 204 shown in FIG. 2. This means that such piezoelectric actuators cannot be used with a diode 202 arranged as shown in FIG. 2, requiring a choice to be made between the use of micro-actuation or the use of thermally assisted recording.

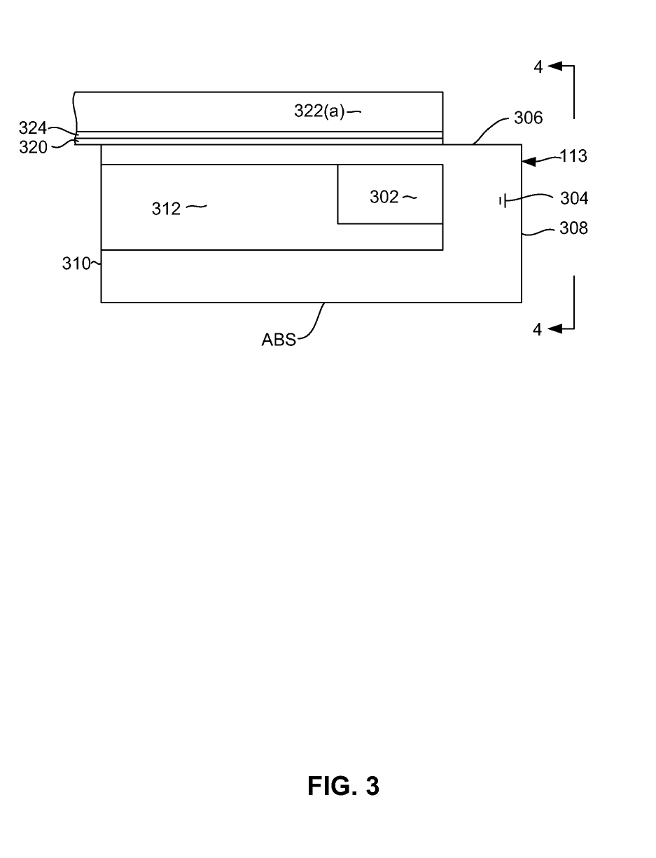

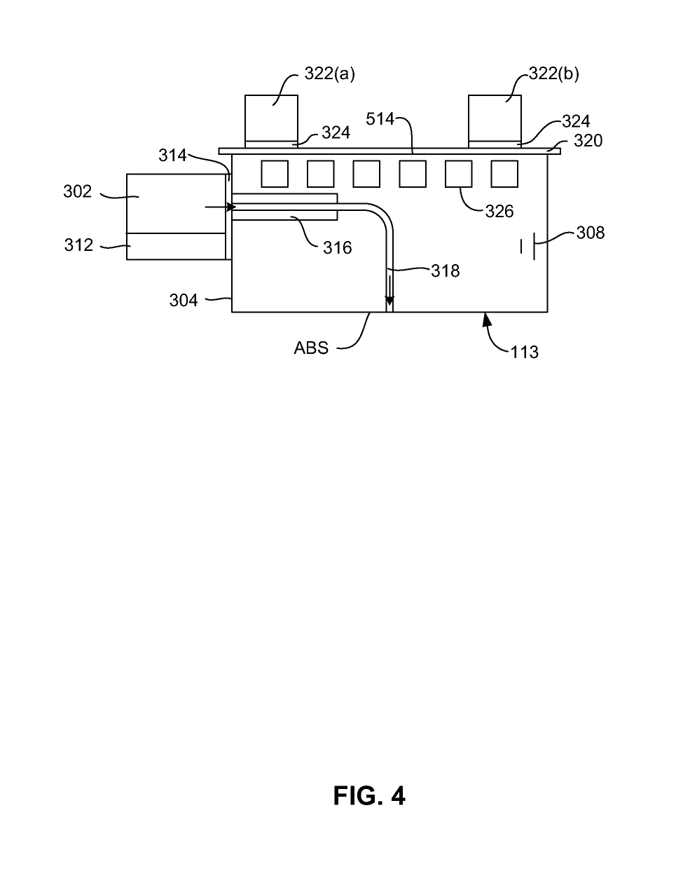

The present invention overcomes these challenges, allowing the use of thermally assisted recording with piezoelectric micro-actuation, and also allowing increased diode size without the possibility of contact or interference between diodes of adjacent sliders. FIG. 3 is a side view of a slider 113 according to an embodiment of the invention, and FIG. 4 is an end view as seen from line 4-4 of FIG. 3. As shown in FIG. 3, in an embodiment of the invention a laser diode 302 is mounted on a side surface 304 of the slider 113. That is to say, the laser diode 302 is not mounted on a back surface 306 opposite the air bearing surface (ABS). Rather, the side surface 304 on which the laser diode 302 is mounted is perpendicular to both the ABS surface and the back surface 306 and extends between the back surface 306 and the ABS surface. As shown in FIGS. 3 and 4, the side surface 304 is also perpendicular to and extends between a trailing end surface 308 and a leading end surface 310.

The laser diode 302 can be mounted to the side 304 of the slider 113 by attaching it to a sub-mount 312. The sub-mount 312 can, in turn be attached to the slider body by an adhesion layer 314. With reference to FIG. 4, light from the laser diode 302 can be passed through a spot size converter 316 to control the size of the light spot, and can be passed through a wave guide 318 that has 90 degree bend 320 that allows waveguide 318 to pass from the side 304 to the ABS surface of the slider 113. This 90 degree bend in the waveguide 318 allows the laser diode 302 to generate a light spot at a desired location at the ABS even though the laser diode is mounted at the side 304 rather than at the back surface 306.

Locating the laser diode 302 at the side 304 of the slider rather than at the back surface 306 provides advantages that overcome the challenges discussed above. First, with the laser diode 302 located at the side 304, there is no chance of a laser diode from one slider contacting the laser diode of another adjacent slider in the suspension assembly. Therefore, the size of the laser diode is not limited as was the case with the structure described above with reference to FIG. 2. The laser diode can be constructed large enough to meet the power needs and design requirements of any thermally assisted magnetic recording system.

Another benefit of mounting the laser diode 302 at the side 304 of the slider 113 rather than the back surface 306 is that it provides unlimited space on the backside 306 for attaching a micro-actuator. As seen in FIGS. 3 and 4, the slider 113 is connected with a flexure 320. A pair of piezoelectric actuators 322(a), 322(b) (both of which can be seen in FIG. 4) are connected with the flexure 320, such as by use of an adhesion layer 324. As can be seen, because the laser diode is located at the side 304 of the slider 113, there is ample space on the back side 306 for connecting the piezoelectric actuators 322(a), 322(b), allowing both micro-actuation and thermally assisted recording to be used in the same recording system. In FIG. 4, several electrical connection pads 326 can be seen formed on the trailing end surface 308. These connection pads can be used for electrically connecting arm electronics with the read and write elements which are not shown here for purposes of clarity but which would be located in a magnetic head formed at the trailing end surface 308 of the slider 113.

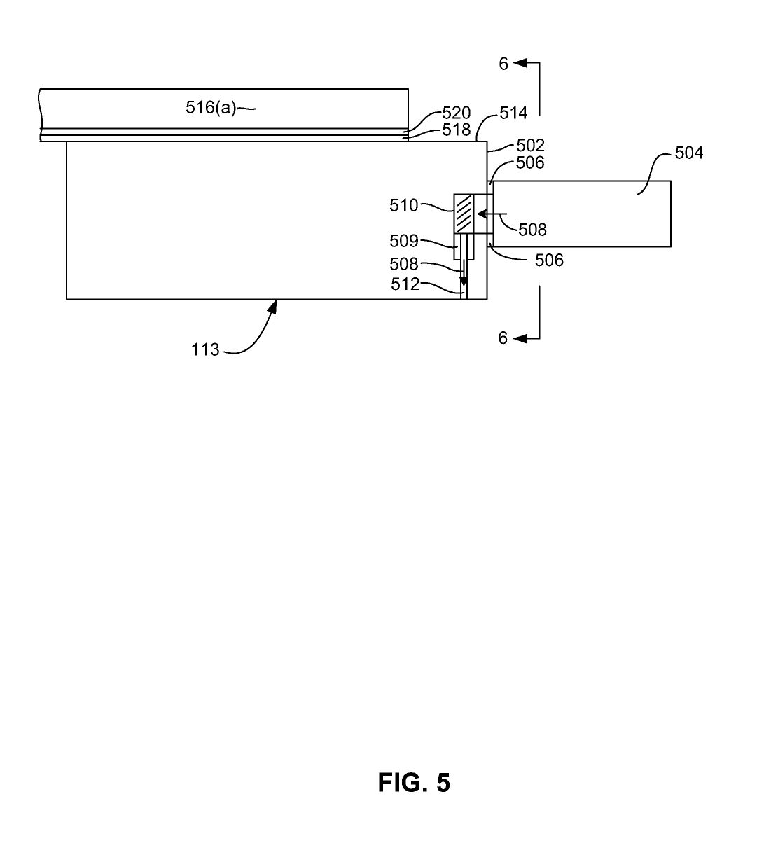

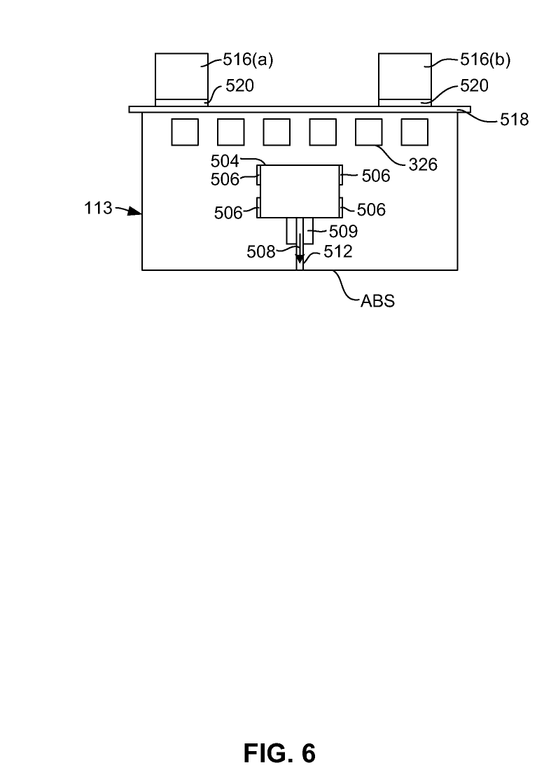

FIGS. 5 and 6 illustrate another possible embodiment of the invention. FIG. 5 is a side view of a slider 113 and FIG. 6 is an end view of the slider 113, showing the trailing end 502 of the slider 113 as seen from line 6-6 of FIG. 5. In the embodiment shown in FIGS. 5 and 6, a laser diode 504 is attached to the trailing end surface 502 rather than to the side. The laser diode can be attached to the trailing end surface 502 by one or more adhesion layers 506. Light (represented arrow 508) from the laser diode 504 can be passed through a grating element 510 in order to bend it at a 90 degree angle or near 90 degree angle. A spot size converter 509 may also be provided to control the size of the light spot delivered to the ABS. The bent light 508 then passes through a waveguide 512 which directs the light toward the desired location at the air bearing surface ABS.

As with the previously described embodiment, the placement of the laser diode 504 at the trailing end surface 502, leaves the back surface 514 (opposite the ABS) completely unobstructed for connection with a pair of micro-actuators such as piezoelectric actuators 516(a) 516(b). The micro-actuators 516(a), 516(b) can be connected with the back side surface 514 via a flexure 518. The micro-actuators 516(a), 516(b) can be connected with the flexure 518 by adhesion layers 520. Also, as shown in FIG. 6, the trailing edge surface can include contact pads 326 for making electrical connection with the read and write elements, which are not shown in FIG. 5.

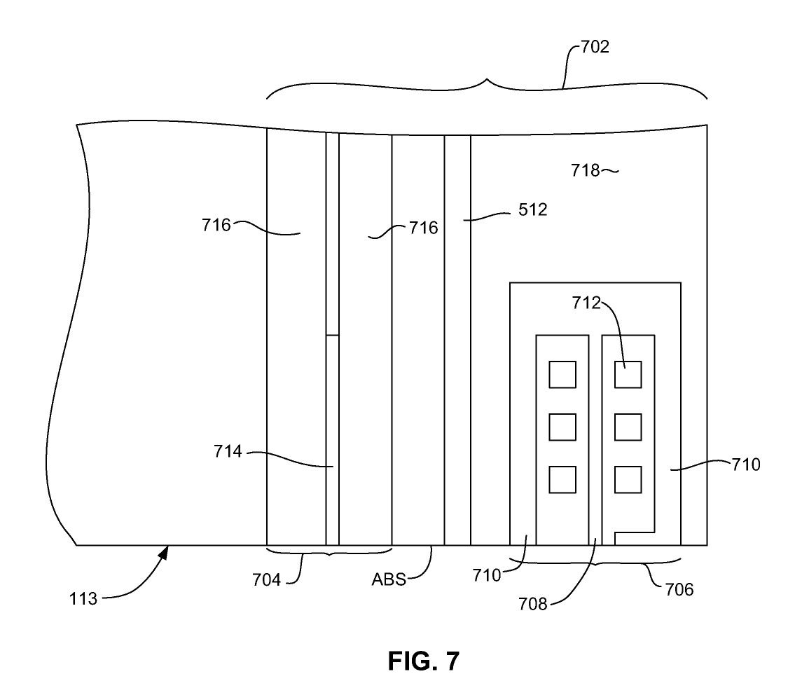

FIG. 7 shows an enlarged view of the ABS region of a magnetic head formed on the trailing edge of a slider 113. The magnetic head includes a read element 704 and a write element 706. The write element 706 can include a magnetic write pole 708, one or more magnetic return poles 710 and a non-magnetic write coil 712, shown in cross section in FIG. 7. The read element 704 can include a magnetoresistive sensor 714 sandwiched between first and second magnetic shields 716. The read and write elements 704, 706 can be embedded in a non-magnetic, electrically insulating fill material 718, such as alumina.

With continued reference to FIG. 7, the wave guide 512 passes through the magnetic head 702, extending through to the air bearing surface (ABS). The wave guide 512 is preferably located close to the magnetic write element 706. While the wave guide 512 is shown in FIG. 7 as being located between the read and write elements 704, 706, this is only a possible embodiment of the invention and is shown this way for purposes of illustration. The waveguide 512 could also extend through the write element 706 to locate it as close as possible to the write pole 708.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

1. A slider for magnetic data recording, comprising:
a slider body having an air bearing surface, and a side surface oriented perpendicular to the air bearing surface; and
a laser diode attached to the side surface of the slider body.

2. The slider as in claim 1 wherein the laser diode extends from the side surface in a direction that is substantially parallel with the air bearing surface.

3. The slider as in claim 1 wherein the slider body has a trailing end surface that is oriented perpendicular with both the air bearing surface and the side surface.

4. The slider as in claim 1 further comprising a magnetic head structure that includes a magnetic read element, a magnetic write element and a wave guide, the wave guide being formed with a bend and configured to deliver light from the laser diode to the air bearing surface.

5. The slider as in claim 1 further comprising a sub-mount structure connected with the laser diode for mounting the laser diode to the side surface of the slider body.

6. The slider as in claim 1 further comprising a spot size converter connected with the laser diode.

7. The slider as in claim 1 wherein the slider body has a back surface located opposite to the air bearing surface, the slider further comprising, a pair of micro-actuators connected with the back surface of the slider body.

8. The slider as in claim 1 wherein the slider body has a back surface located opposite to the air bearing surface, the slider further comprising, a flexure connected with the back surface of the slider body, and a pair of micro-actuators connected with the flexure.

9. The slider as in claim 7 wherein the micro-actuators are piezoelectric actuators.

10. The slider as in claim 8 wherein the micro-actuators are piezoelectric actuators.

11. A slider for magnetic data recording, comprising:
a slider body having an air bearing surface, and a trailing end having a read element and a write element located thereon, the trailing end having a trailing end surface oriented perpendicular to the air bearing surface; and
a laser diode attached to the trailing end surface of the slider body.

12. The slider as in claim 11 further comprising a grating element formed on the trailing end of the slider body and configured to change the direction of light emitted from the laser diode.

13. The slider as in claim 12 further comprising a wave guide configured to deliver light from the grating element to the air bearing surface of the slider body.

14. The slider as in claim 11 wherein the slider body has a back surface located opposite to the air bearing surface, the slider further comprising, a pair of micro-actuators connected with the back surface of the slider body.

15. The slider as in claim 11 wherein the slider body has a back surface located opposite to the air bearing surface, the slider further comprising, a flexure connected with the back surface of the slider body, and a pair of micro-actuators connected with the flexure.

16. The slider as in claim 14 wherein the micro-actuators are piezo-electric actuators.

17. (canceled)

18. The slider as in claim 15 wherein the micro-actuators are piezo-electric actuators.

19. A magnetic data recording system, comprising:
a housing;
a magnetic media mounted within the housing;
an actuator;
a slider connected with the actuator for movement adjacent to a surface of the magnetic media, the slider having an air bearing surface configured to face the surface of the magnetic media and a surface that is oriented perpendicular to the air bearing surface, and a laser diode connected with the surface that is oriented perpendicular to the air hearing surface.

20. The magnetic data recording system as in claim 19 wherein the surface that is perpendicular to the air bearing surface is a side surface that is oriented perpendicular to a trailing end surface.

21. The magnetic data recording system as in claim 19 wherein the surface that is oriented perpendicular to the air hearing surface is a trailing end surface.

22. The magnetic data recording system as in claim 19 further comprising a pair of micro-actuators connected with a back side surface of the slider that is opposite to and parallel with the air bearing surface.

23. The magnetic data recording system as in claim 19 further comprising a pair of micro-actuators connected a flexure that is connected with a back side surface of the slider that is opposite to and parallel with the air hearing surface.
